(19) United States
(12) Patent Application Publication
(10) Pub. No.: US 2024/0267112 A1
(43) Pub. Date: Aug. 8, 2024

(54) DYNAMIC FORWARDING CONFIGURATION OF MOBILE REPEATER

(71) Applicant: QUALCOMM Incorporated, San Diego, CA (US)

(72) Inventors: Naeem AKL, Bridgewater, NJ (US); Navid ABEDINI, Basking Ridge, NJ (US); Tao LUO, San Diego, CA (US); Junyi LI, Fairless Hills, PA (US)

(21) Appl. No.: 18/164,456

(22) Filed: Feb. 3, 2023

(51) Int. Cl. H04B 7/15; H04L 5/00

(52) U.S. Cl. CPC H04B 7/15; H04L 5/0048

(57) ABSTRACT

Certain aspects of the present disclosure provide techniques for dynamically updating a forwarding configuration of a mobile repeater. An exemplary method for wireless communications at a repeater includes modifying a forwarding behavior based on a change in channel condition of a communications link between the repeater and a network entity and forwarding one or more communications between the network entity and a user equipment (UE) in accordance with the modified forwarding behavior.

### BACKGROUND

### Field of the Disclosure

Aspects of the present disclosure relate to wireless communications, and more particularly, to techniques for dynamically updating a forwarding configuration of a mobile repeater.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication at a repeater. The method includes modifying a forwarding behavior based on a change in channel condition of a communications link between the repeater and a network entity; and forwarding one or more communications between the network entity and a user equipment (UE) in accordance with the modified forwarding behavior.

Another aspect provides a method for wireless communication by a network entity. The method includes: outputting, for transmission to a repeater, a configuration, wherein the configuration configures the repeater to at least one of: detect a change in channel condition of a communications link between the repeater and the network entity; modify a forwarding behavior of the repeater based on the change in channel condition; and outputting, for transmission to the repeater, a communication having a user equipment (UE) as an intended recipient.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts a block diagram of an example wireless system deploying repeaters.

FIG. 6 illustrates an example scenario for deploying repeaters.

FIG. 7 illustrates an example wireless system deploying repeaters.

FIG. 8 is a block diagram of an example architecture of a repeater.

FIG. 9 depicts an example logical architecture of a network-controlled repeater (NCR), in accordance with aspects of the present disclosure.

FIGS. 10A and 10B illustrate an example UE mobility scenario where a UE interacts with a cell without involvement of a repeater.

FIGS. 11A and 11B illustrate an example UE mobility scenario where a UE and an repeater move together through a cell.

FIG. 12 depicts a process flow for communications in a network between a network entity, a repeater, and a UE.

FIG. 13 depicts a method for wireless communications.

FIG. 14 depicts a method for wireless communications.

FIG. 15 depicts aspects of an example communications device.

FIG. 16 depicts aspects of an example communications device.

### DETAILED DESCRIPTION

Aspects of the present disclosure provide apparatuses, methods, processing systems, and computer-readable mediums for dynamically updating a forwarding configuration of a mobile repeater.

A repeater may improve coverage provided by a network by enabling signals from a network entity to reach areas that the signals are otherwise obstructed from reaching (e.g., by an object, such as a building or a tree). A repeater may be mobile or stationary and may operate in an autonomous mode or in a network-controlled mode. A repeater operating in a network-controlled mode may be referred to as a network-controlled repeater (NCR). As a repeater that is mobile moves within a cell, the repeater may move out of a coverage area of a first beam (e.g., a beam used to transmit a synchronization signal block (SSB)) from a network entity and into a second beam's coverage area. When a UE and a repeater move together (e.g., both are in a vehicle), the UE observes SSB beam variations through the repeater, as the repeater forwards SSB beams to the UE while the repeater and the UE move together. Altering the beams that are transmitted to the UE may enable the repeater to improve the signal quality experienced by the UE and enable the repeater to conserve power.

In aspects of the present disclosure, a repeater may modify a forwarding behavior (e.g., a behavior of forwarding SSB beams to a UE) based on a change in channel condition of a communications link between the repeater and a network entity. Thus, a repeater traveling with a UE may selectively alter beam forwarding to the UE, based on the signal conditions to the network entity detected by the repeater. The repeater may, for example, activate or deactivate forwarding, modify a beam-specific amplification gain, modify an access beam configuration, modify an access beam sweep beam pattern, or cease transmitting a beam.

A repeater may provide improved SSB beam coverage to a UE by modifying the repeater's forwarding behavior in response to detecting changes in channel conditions of a link to a network entity. The improved SSB beam coverage may include the repeater selectively forwarding only strong beams, equalizing the strengths of beams observed by the UE. The repeater may also conserve power by modifying the repeater's forwarding behavior.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

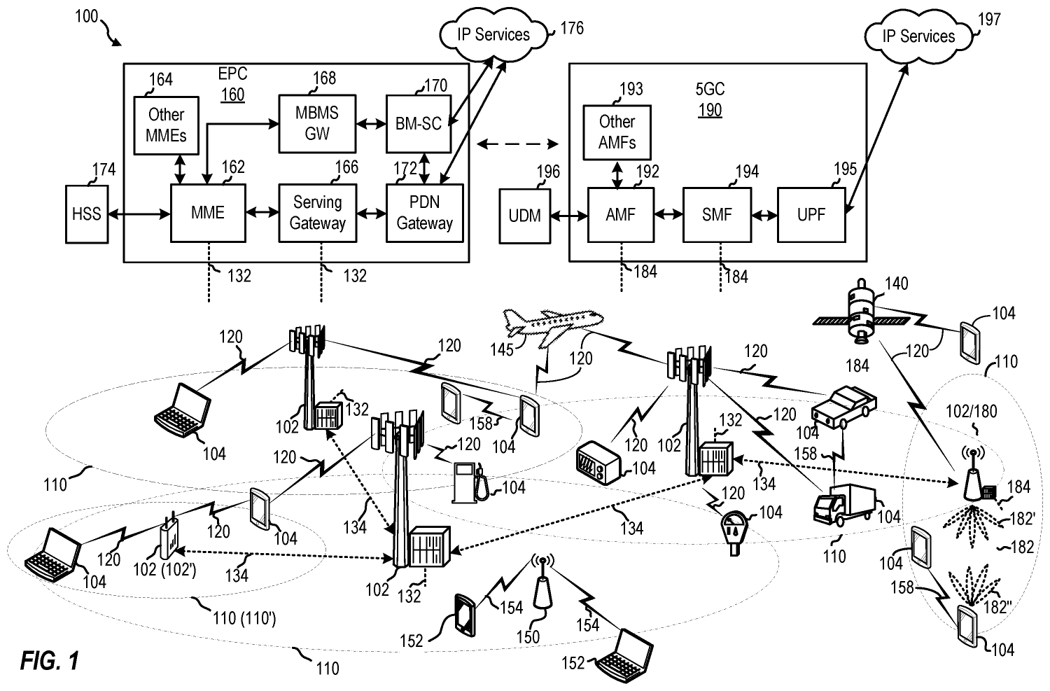

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

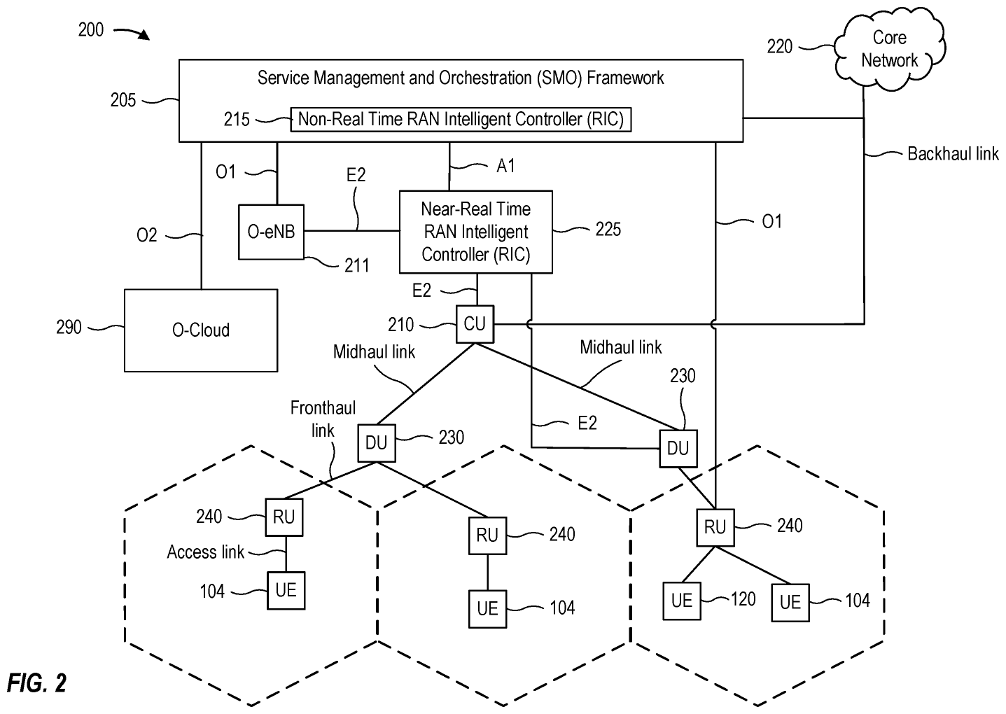

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUS), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mm Wave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

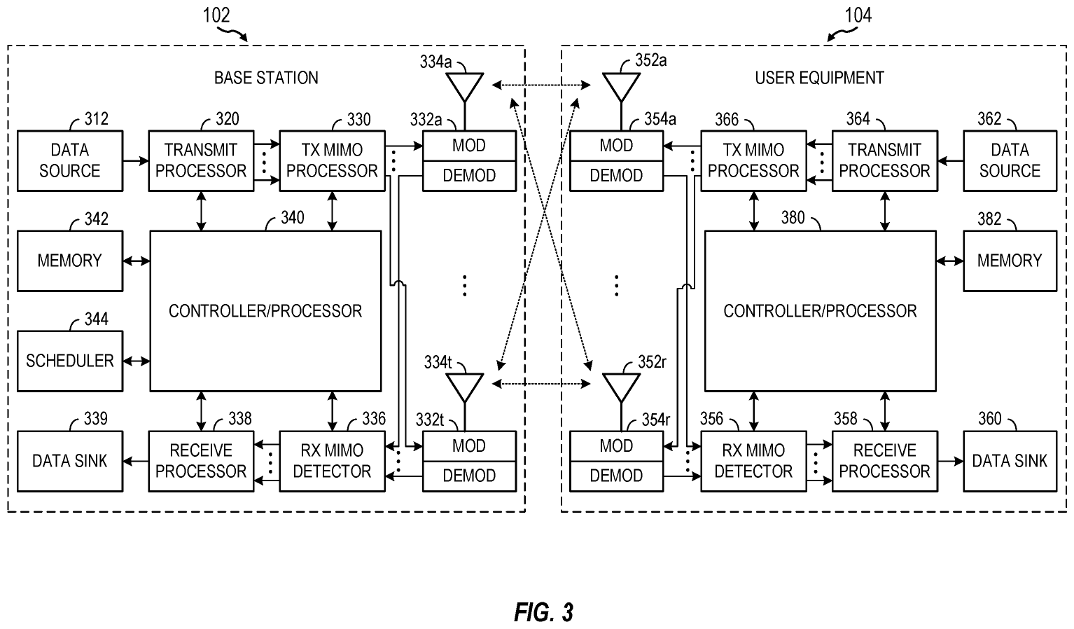

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

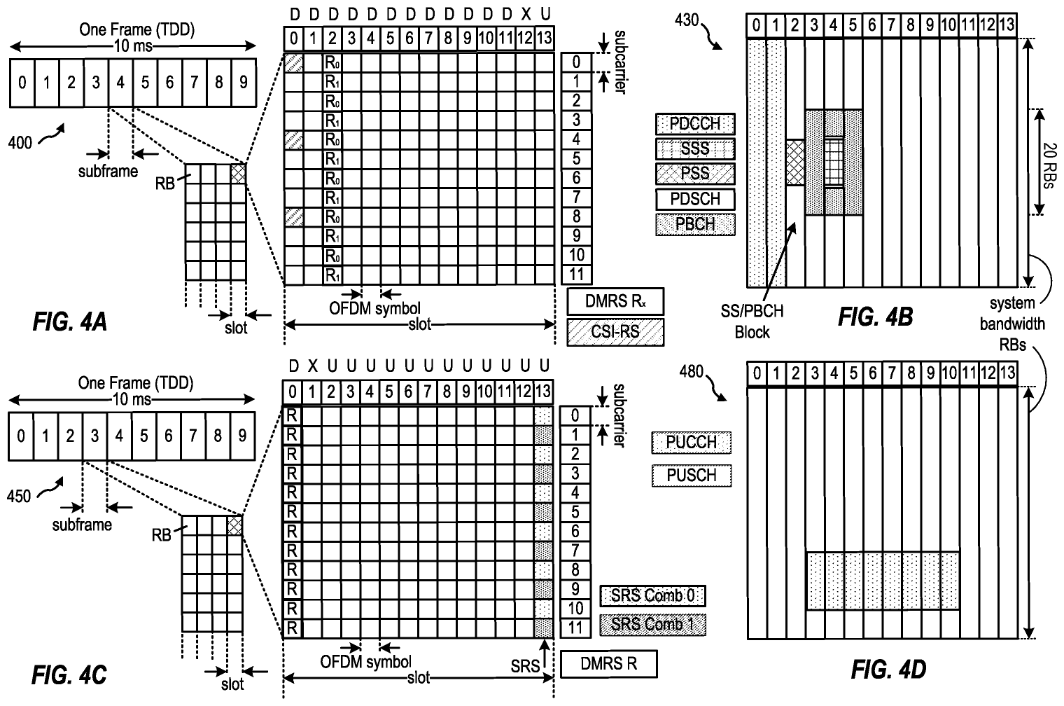

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where Dis DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2μ slots/subframe. The subcarrier spacing and symbol length/duration are a function of the numerology. The subcarrier spacing may be equal to 2^{μ}×15 kHz, where u is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Overview of Repeaters

Next generation (5th generation (5G)) wireless networks have stated objectives to provide ultra-high data rate and support wide scope of application scenarios. Integrated access and backhaul (IAB) systems may help realize these objectives.

In an IAB system, a wireless backhaul solution is adopted to connect cells, which may be referred to as relays or IAB-nodes, to a core network that uses a wired backhaul. Some attractive characteristics of IAB systems are support for multi-hop wireless backhaul, sharing of a same technology (e.g., new radio (NR)) for both access and backhaul links, and sharing of resources (e.g., frequency bands) for both access and backhaul links.

There are various possible architectures for IAB-nodes, including layer-2 (L2) and layer-3 (L3) solutions, and a particular architecture deployed may depend on what layers of protocol stack are implemented in intermediate nodes (IAB-nodes). For example, L2 relays may implement physical (PHY)/medium access control (MAC)/radio link control (RLC) layers.

Certain aspects of the present disclosure relate to L1 relays, also referred to as repeaters. Repeaters may have many desirable features. For example, such repeaters are relatively simple, low-cost, low-power, and are wirelessly connected to a donor or another relay (e.g., a gNodeB (gNB)).

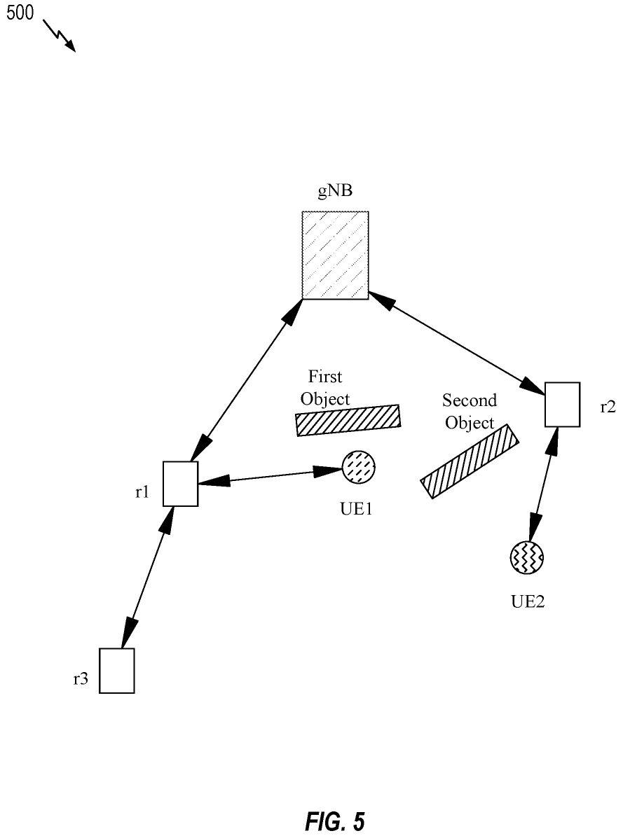

FIG. 5 illustrates one example application of repeaters in a wireless communication system 500. The repeaters may help improve coverage by overcoming blockage (for instance, obstruction of radio frequency (RF) signals by an object).

Blockage may be a major issue in millimeter wave (mmW) communications systems, where beamforming is used to send directional RF signals. In the illustrated example, repeaters r1, r2, and r3 may allow a gNB to serve UE1 and UE2 even though objects prevent the gNB directional RF signals from reaching the UEs.

As illustrated, because the repeater r1 is not blocked from receiving RF signals from the gNB by the objects, the repeater r1 may receive the RF signals from the gNB and re-transmit the RF signals to reach UE1, even though UE1 is blocked by a first object (e.g., a building or tree) from receiving the RF signals directly from the gNB. Similarly, because the repeater r2 is not blocked from receiving RF signals from the gNB by the objects, the repeater r2 may receive the RF signals from the gNB and re-transmit the RF signals to reach UE2, even though UE2 is also blocked from receiving the RF signals directly from the gNB by a second object. As demonstrated by this example, repeaters may serve as relatively simple and inexpensive solutions that may prevent blockage of UEs by the objects, extend the coverage of a mmW cell, and fill coverage holes in a mmW cell.

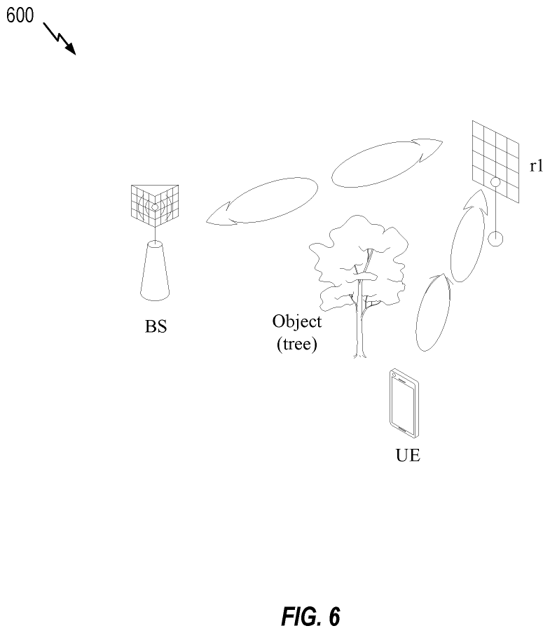

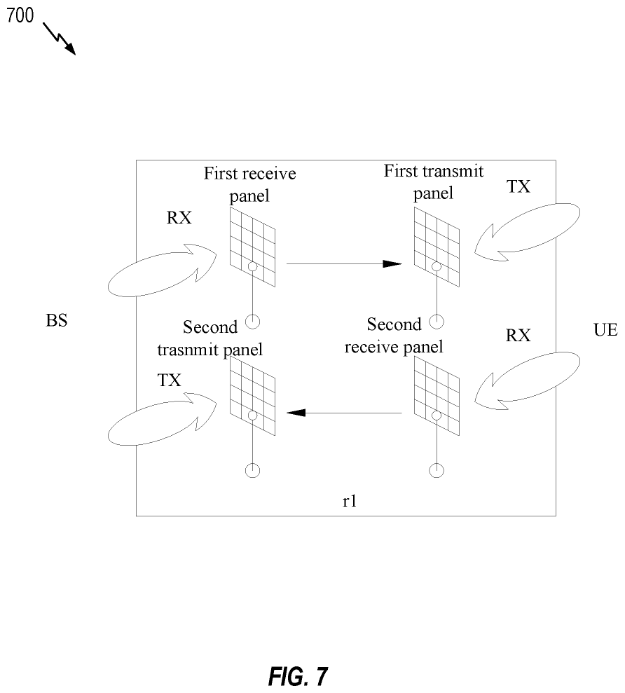

FIGS. 6 and 7 provide additional examples of how repeaters may help effectively overcome blockage by one or more objects in a cell. As illustrated in a wireless communication system 600 of FIG. 6, a repeater r1 receives at least one RF signal in one panel (corresponding to a receive or Rx beam) and (re-)transmits the RF signal in another panel (corresponding to a transmit or Tx beam). For example, the repeater r1 amplifies the received RF signal and forwards the RF signal to become the transmitted RF signal received by the UE. Such an operation may be referred to as amplify-and-forward.

In the example illustrated in FIG. 6, the repeater r1 is able to receive an RF signal (for example, a downlink (DL) transmission) from a BS and relay the RF signal to a UE, which may be blocked from receiving the RF signal directly from the BS due to presence of an object (e.g., a tree) between the BS and the UE. Similarly, the repeater r1 may receive an RF signal (for example, an uplink (UL) transmission) from the UE and relay that RF signal to the BS.

As illustrated in a wireless communication system 700 of FIG. 7, a repeater r1 may include receive panels (for example, a first receive panel and a second receive panel) and transmit panels (for example, a first transmit panel and a second transmit panel), which may be used to implement fixed beam patterns. For wide coverage, the beam patterns are usually wide, therefore not achieving high array gains. The repeater r1 is may not be aware of whether a signal (e.g., RF signal) is a DL signal or an UL signal in a time division duplex (TDD) system and may operate in both directions (i.e., full duplex) simultaneously.

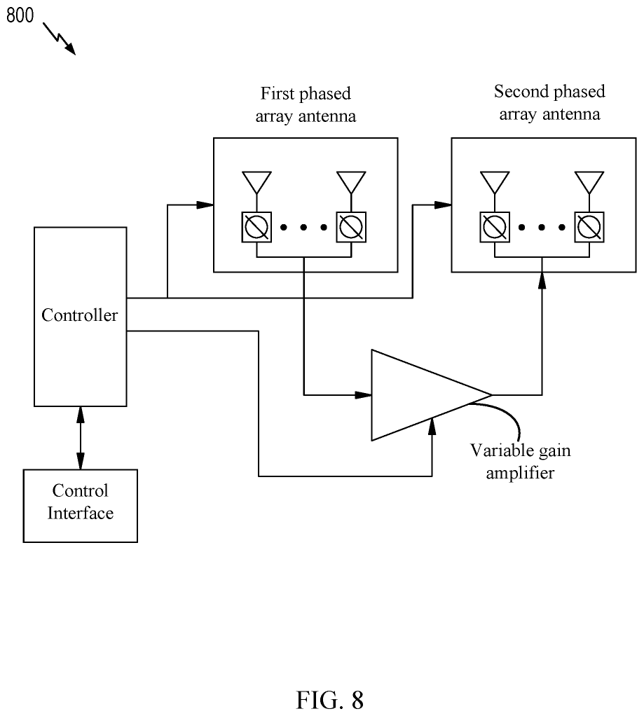

FIG. 8 illustrates a schematic view of an example architecture 800 for a repeater (e.g., L1 repeater). As noted above, the repeater may receive an analog RF signal on receive antennas of the repeater (e.g., based on some configured RX beamforming), amplify power of the received analog RF signal, and transmit the amplified analog RF signal from transmit (TX) antennas of the repeater (e.g., based on some configured TX beamforming).

As illustrated in FIG. 8, beamforming by a repeater may be accomplished via phased array antennas (for example, a first phased array antenna and a second phased array antenna) configured by a controller, while the amplification may be accomplished by a variable gain amplifier. The repeater may also communicate some control signals with a server (e.g., a BS serving as a donor, a control node, etc.) via a control interface. The control interface may be implemented in-band (e.g., using a smaller bandwidth part of a same carrier frequency).

As noted above, a repeater may be a relay node with amplify-and-forward operation between two wireless nodes (e.g., a network entity and a UE) and may provide a simple and cost-effective way to improve network coverage. Other types of relay nodes include a decode-and-forward relay node, e.g., an IAB node. In some cases, performance of the repeater may be improved based on side information. The side information may include timing information (e.g., a slot, symbol, subframe, and/or frame boundary), a time division duplex (TDD) UL/DL configuration, ON-OFF scheduling information, and/or spatial information for beam management.

A repeater may operate in a traditional mode, an autonomous mode, or in a network-controlled mode. A repeater operating in the traditional mode may operate without side information to provide amplify-and-forward operations between two wireless nodes.

A repeater operating in autonomous mode may either directly or via a cloud-based management entity acquire or infer information useful for communication operations. For example, a repeater operating in autonomous mode may acquire information to use in communications by receiving and/or decoding broadcast channels.

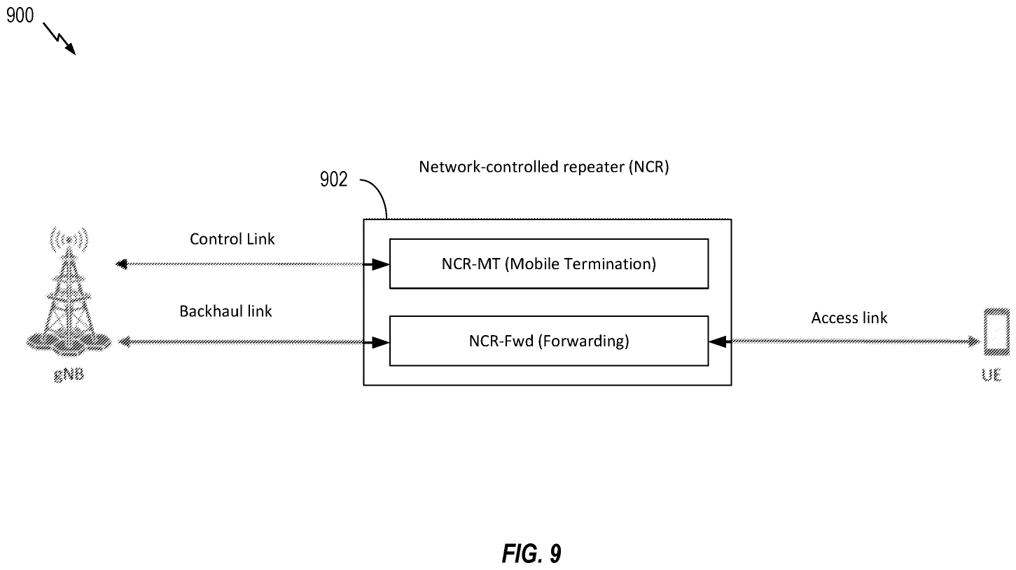

FIG. 9 depicts an example logical architecture of a network-controlled repeater (e.g., a repeater operating in network-controlled mode), in accordance with aspects of the present disclosure. As illustrated, an NCR may include an NCR mobile termination (NCR-MT) function and an NCR forwarding (NCR-Fwd) function. The NCR-MT function may have a Uu-based control link for exchange of side control information with a gNB, as illustrated, or another network entity. The NCR-Fwd function may perform amplifying-and-forwarding of UL and/or DL RF signals between the gNB and a UE via the backhaul (BH) link and the access link. It is desirable for at least one of the NCR-MT's carriers to operate in the frequency band forwarded by the NCR-Fwd function, so that the channel for the control link on which the repeater receives the side control and the backhaul link for forwarding are similar, and/or to facilitate beam management of the backhaul for forwarding based on beam management for the control link, and/or to have similar subcarrier spacing for time management of the control link and the backhaul link for forwarding. Transmission and reception on the control link and BH link may be time domain multiplexed (TDMed) or performed simultaneously, depending on capabilities of the NCR.

Side control information for the NCR may include beam information for the access link, a TDD UL/DL configuration for the cell, ON-OFF information for the forwarding behavior, and/or power control information. The ON-OFF information for the forwarding behavior may, for example, refer to the NCR knowing when to activate forwarding and when to deactivate forwarding (e.g., deactivate forwarding if there is no signal and forwarding would amount to amplifying noise and interference).

A network-controlled repeater may be configured and/or controlled with the side information by a network node (e.g., a gNB) via an established control interface. In one example, all side information may be provided by the gNB. In another example, part of the side information may be configured/controlled by the gNB, while remaining side information may be acquired/infer by the network-controlled repeater itself. This may reduce a control overhead and/or a latency of the network-controlled repeater.

### Overview of Mobile Repeaters

In some cases, a repeater may be deployed in a fixed and static location to provide amplify-and-forward operation between two wireless nodes.

In some cases, a repeater may be mobile (e.g., deployed in a vehicle such as a bus). A mobile repeater (e.g., in a vehicle) may provide better coverage for some user equipments (UEs). For example, an in-vehicle repeater may provide improved coverage for in-vehicle UEs by compensating for losses associated with the signal penetrating to the interior of the vehicle. The mobile repeater may also serve UEs near the vehicle (such as the UEs with pedestrians and in moving cars).

In some cases, a repeater operating in a network-controlled mode (e.g., an NCR) may use a UE modem to establish a radio resource control (RRC) connection with a network entity. The modem may also perform radio resource management (RRM) measurements, and report the RRM measurements to a serving cell of the repeater operating in network-controlled mode.

In some cases, the network entity may have information associated with the repeater. The information may include a type of the repeater, functionality of the repeater, UEs being served by the repeater, a traffic demand of the repeater, and quality of service (QoS) requirements of the repeater.

In some cases, when a repeater operating in network-controlled mode is moving through a network and the repeater is to perform a hand over (HO) from a current cell to a target cell, the network entity may decide to which target cell the repeater (and its associated UEs) may hand over. The network entity may determine the target cell based on measurements made by the repeater, measurements made by the UEs, UE requirements, and/or cell loads.

In some cases, a repeater operating in autonomous mode may operate transparently to a network entity. In some cases, the repeater operating in autonomous mode may communicate with a cloud-based management entity. In some cases, the repeater operating in autonomous mode may be self-sufficient to operate.

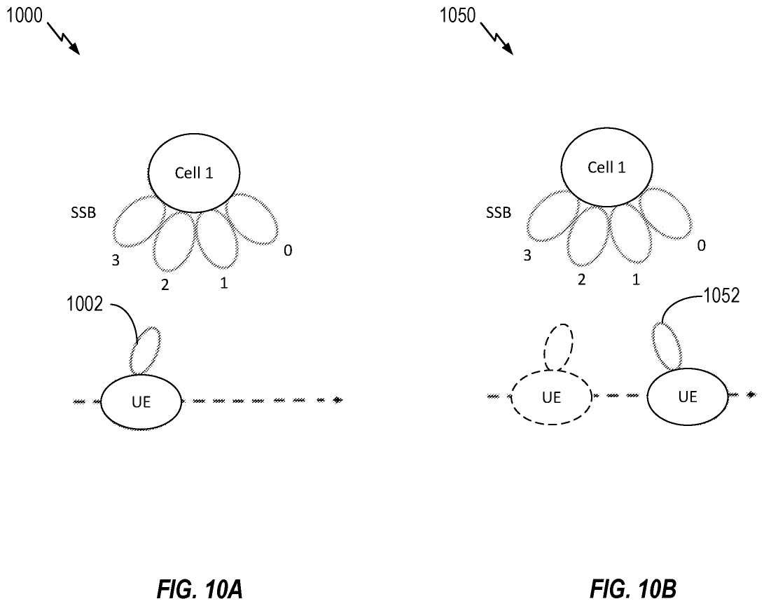

FIGS. 10A and 10B illustrate an example UE mobility scenario where a UE interacts with a cell without involvement of a repeater. In the example mobility scenario, a cell broadcasts a “fixed” SSB pattern, and the UE observes beam variations due to the mobility of the UE. As illustrated by the network diagram 1000 in FIG. 10A, at a first time, the UE is moving with respect to the cell and receives transmissions, such as SSB beam 2, using a receive beam 1002. As illustrated by the network diagram 1050 in FIG. 10B, at a later time, the UE has moved to a new position and observes a stronger beam 1 and a weaker beam 2. The UE changes receive beam configuration to receive transmissions, such as SSB beam 1, using a receive beam 1052.

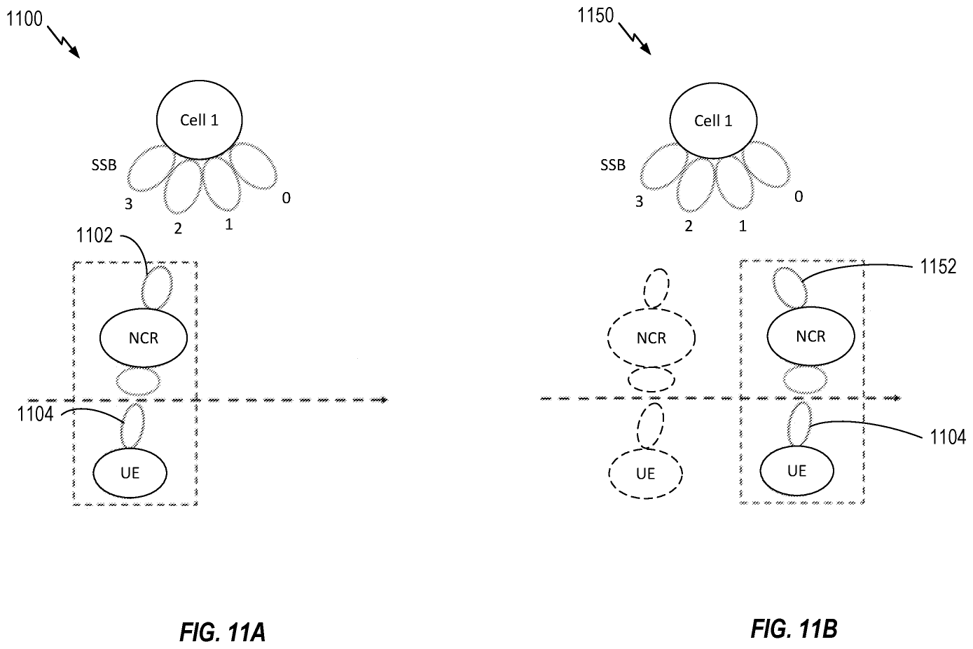

FIGS. 11A and 11B illustrate an example UE mobility scenario where a UE and an NCR move together through a cell. In the example mobility scenario, a cell broadcasts a “fixed” SSB pattern, and the NCR forwards SSB beams to the UE in a “stationary” manner, i.e., the NCR is stationary with respect to the UE, and the NCR forwards SSB beams to the UE as if the UE were moving through the cell without the NCR, as shown in FIGS. 10A and 10B. Repeaters may be transparent to UEs, such that the UEs may be unaware of the presence and activity of the NCR. As the NCR and UE move together through the cell, the UE observes beam variations that the NCR observes and reproduces. As illustrated by the network diagram 1100 in FIG. 11A, at a first time, the UE and NCR are moving with respect to the cell and the NCR receives transmissions, such as SSB beam 2, using a receive beam 1102 and forwards the transmissions to the UE, which receives the transmissions using the receive beam 1104. As illustrated by the network diagram 1150 in FIG. 11B, at a later time, the UE and NCR have moved to a new position, and the NCR observes a stronger beam 1 and a weaker beam 2. The NCR changes receive beam configuration to receive transmissions, such as SSB beam 1, using a receive beam 1152, while the UE continues receiving the transmissions using the receive beam 1104.

### Aspects Related to Dynamically Updating a Forwarding Configuration of a Mobile Repeater

A repeater may improve coverage provided by a network by enabling signals from a network entity to reach areas that the signals are otherwise obstructed from reaching (e.g., by an object, such as a building or a tree). A repeater may be mobile or stationary and may operate in an autonomous mode or in a network-controlled mode. A repeater operating in a network-controlled mode may be referred to as a network-controlled repeater (NCR). As a repeater that is mobile moves within a cell, the repeater may move out of a coverage area of a first beam (e.g., a beam used to transmit a synchronization signal block (SSB)) from a network entity and into a second beam's coverage area. When a UE and a repeater move together (e.g., both are in a vehicle), the UE observes SSB beam variations through the repeater, as the repeater forwards SSB beams to the UE while the repeater and the UE move together.

In aspects of the present disclosure, a repeater (e.g., an NCR) detects channel variation on a backhaul link (e.g., by the NCR-MT). The repeater may modify a forwarding behavior of the NCR-Fwd of the repeater on the access link based on the detected channel variation.

According to aspects of the present disclosure, detecting channel variation (e.g., a change in channel condition of a communications link) may refer to a condition on a quantity, computed on a measured reference signal transmitted by the network, becoming fulfilled. Such a condition may be cell-specific (e.g., referring to conditions of the cell serving the repeater) or beam-specific (e.g., referring to a beam on which the repeater is receiving from a network entity). For example, an NCR-MT of a repeater may detect that RSRP of SSB beam 1 exceeds a threshold, or RSRP of SSB beam 1 becomes weaker than RSRP of SSB beam 2 by a threshold amount.

In aspects of the present disclosure, detecting channel variation by a repeater may be based on radio frequency or intermediate frequency (RF/IF) domain measured power, energy, or signal strength within a bandwidth (BW). The bandwidth may be configured on the repeater (e.g., by a network entity).

According to aspects of the present disclosure, detecting channel variation by a repeater may refer to one or more of: activation of a new transmission control indication (TCI) state for the NCR-MT by the network or change of a BH link beam received by the NCR-Fwd function (e.g., a change that may be indicated via a side control info from a network entity).

In aspects of the present disclosure, modifying the forwarding behavior of the repeater may refer to one or more of: 1) activating or deactivating the forwarding (including beam-specific activation or deactivation of forwarding, e.g., a repeater may stop forwarding SSB beam index 0), 2) modifying an amplification gain, such as a beam-specific amplification gain used by the repeater (e.g., equalizing the strengths of beams observed by a UE), 3) modifying the access beam configuration (e.g., by changing a width of the access beam), or 4) modifying the access beam sweep pattern (e.g., switching to no beams or changing directions of beams).

According to aspects of the present disclosure, each of the above-described modifications to forwarding behavior may be made on a directional basis (e.g., affecting forwarding behavior of the UL direction in a different manner than forwarding behavior of the DL direction.)

In aspects of the present disclosure, modifying the forwarding behavior may refer to one or more of: 1) switching to or from an autonomous mode of operation (i.e., not receiving any further side control for any subset of side control info) 2) adjusting the receiving and/or forwarding timing reference or time window, 3) switching to or from digitally processing the incoming signal (e.g., to reduce the impairment or reduce peak-to-average-power ratio PAPR, etc.), 4) switching to generating and transmitting reference signals from forwarding reference signals or vice-versa, or 5) switching to receiving and processing a received signal, such as a RACH or SRS, instead of forwarding the received signal or vice-versa.

According to aspects of the present disclosure, a repeater may receive a configuration from a network entity, and the repeater may determine if backhaul channel variation is detected based on the configuration.

In aspects of the present disclosure, a repeater may receive a configuration from a network entity that activates the modification of forwarding behavior on the access link by the repeater, based on detected backhaul channel variations.

According to aspects of the present disclosure, a repeater may receive a forwarding configuration from the network, and the repeater may modify the forwarding behavior based on the forwarding configuration. In an aspect of the present disclosure, a repeater may receive (e.g., from a network entity) a mapping of forwarding configurations and associated backhaul channel conditions or thresholds, and the repeater may modify the forwarding behavior based on the mapping.

In aspects of the present disclosure, a repeater may notify the network (e.g., a network entity) of a detected backhaul channel variation, based on which the repeater may receive a new forwarding configuration.

According to aspects of the present disclosure, a repeater may notify the network (e.g., a network entity) of a modification of the forwarding behavior of the repeater.

### Example Operations of Entities in a Communications Network

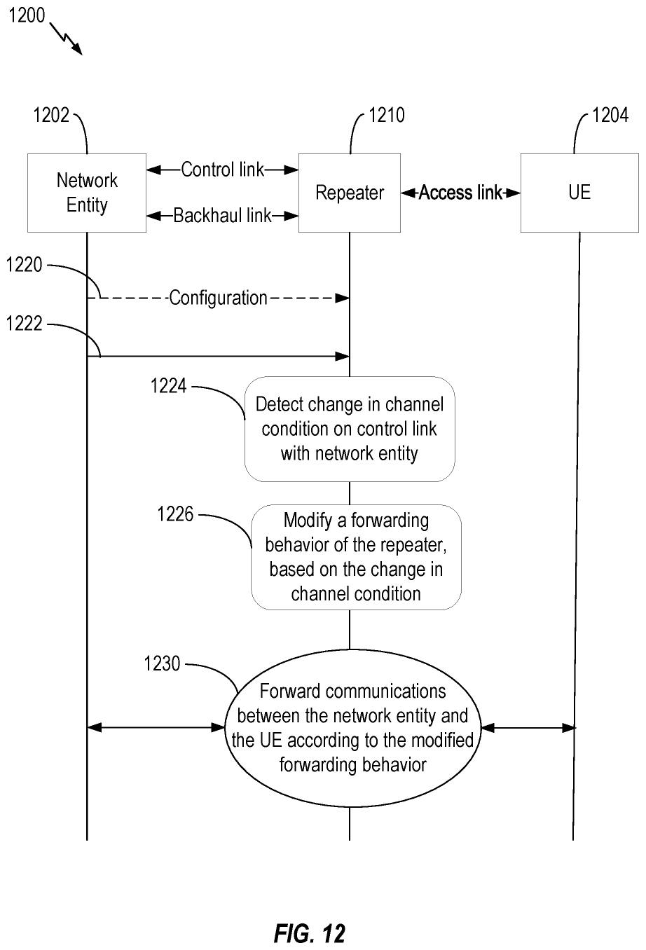

FIG. 12 depicts a process flow 1200 for communications in a network between a network entity 1202, a repeater 1210, and a user equipment (UE) 1204. In some aspects, the network entity 1202 may be an example of the BS 102 depicted and described with respect to FIGS. 1 and 3 or a disaggregated base station depicted and described with respect to FIG. 2. Similarly, the UE 1204 may be an example of UE 104 depicted and described with respect to FIGS. 1 and 3. The repeater 1210 may be an example of repeater 800 or 902 depicted and described with respect to FIGS. 8 and 9. However, in other aspects, repeater 1210 and UE 1204 may be another type of wireless communications device, and BS 1202 may be another type of network entity or network node, such as those described herein.

At 1220, the network entity 1202 optionally transmits a configuration to the repeater 1210.

At 1222, the network entity 1202 transmits a signal, such as a SSB, on the control link to the repeater 1210.

At 1224, the repeater 1210 detects a change in channel condition on the control link with the network entity.

At 1226, the repeater 1210 modifies a forwarding behavior of the repeater, based on the change in channel condition detected at 1224.

At 1230, the repeater forwards communications between the network entity and the UE according to the modified forwarding behavior.

### Example Operations by a Repeater

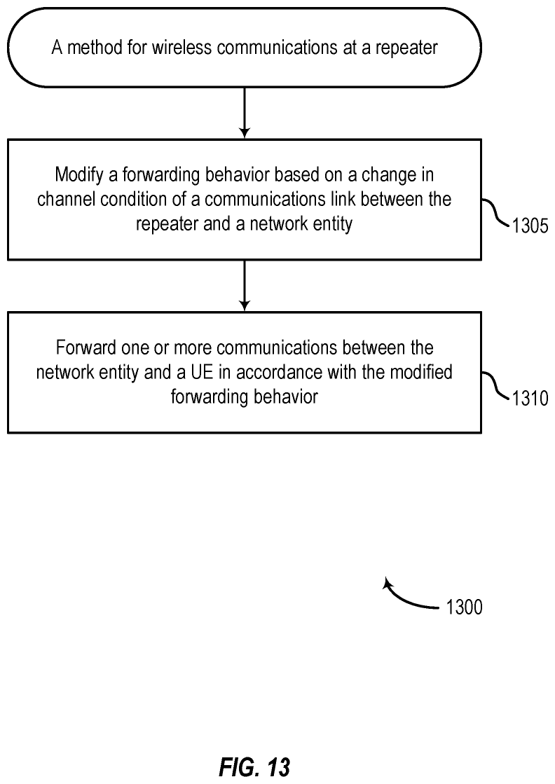

FIG. 13 shows an example of a method 1300 of wireless communication at a repeater, such as by a UE 104 of FIGS. 1 and 3.

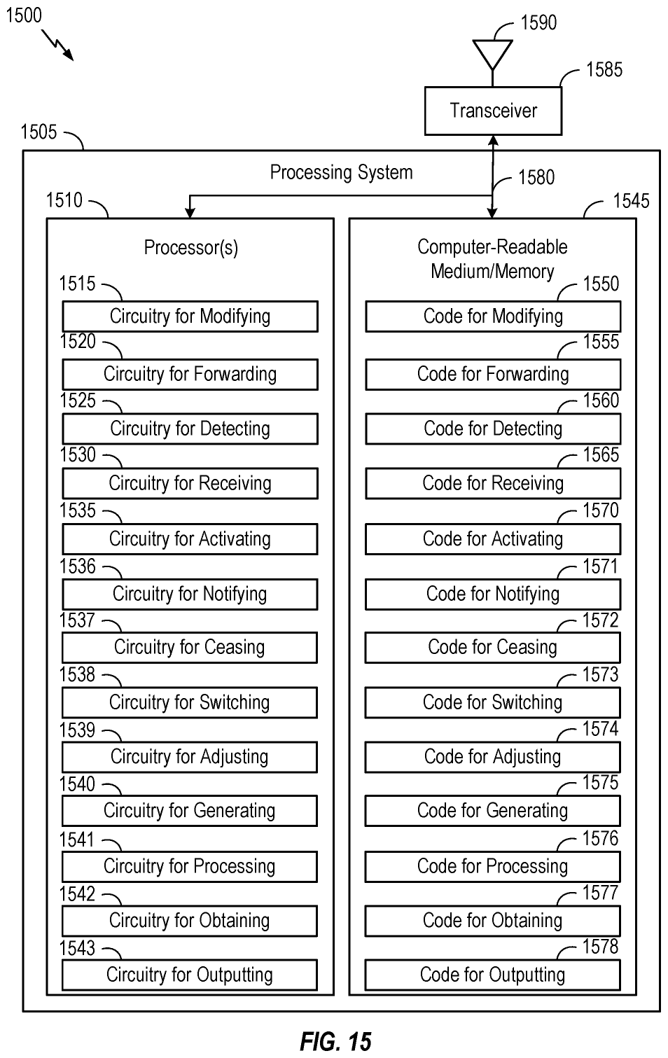

Method 1300 begins at step 1305 with modifying a forwarding behavior based on a change in channel condition of a communications link between the repeater and a network entity. In some cases, the operations of this step refer to, or may be performed by, circuitry for modifying and/or code for modifying as described with reference to FIG. 15.

Method 1300 then proceeds to step 1310 with forwarding one or more communications between the network entity and a UE in accordance with the modified forwarding behavior. In some cases, the operations of this step refer to, or may be performed by, circuitry for forwarding and/or code for forwarding as described with reference to FIG. 15.

In some aspects, the method 1300 further includes detecting the change based on a condition involving at least one of: a reference signal measurement; or a power measurement within a bandwidth. In some cases, the operations of this step refer to, or may be performed by, circuitry for detecting and/or code for detecting as described with reference to FIG. 15.

In some aspects, the method 1300 further includes detecting the change based on at least one of: activation of a TCI state for a MT of the repeater; or a change of a beam of a backhaul link for the repeater. In some cases, the operations of this step refer to, or may be performed by, circuitry for detecting and/or code for detecting as described with reference to FIG. 15.

In some aspects, modifying the forwarding behavior comprises at least one of: activating forwarding by the repeater; deactivating forwarding by the repeater; modifying a beam-specific amplification gain of the repeater; modifying an access beam configuration of the repeater; modifying an access beam sweep pattern of the repeater; or ceasing transmitting a beam.

In some aspects, modifying the forwarding behavior comprises modifying the forwarding behavior for downlink communications from the network entity independent of the forwarding behavior for uplink communications to the network entity.

In some aspects, modifying the forwarding behavior comprises at least one of: switching to an autonomous mode of operation; switching from the autonomous mode of operation; adjusting a receive timing reference; adjusting a forwarding timing reference; switching to digitally processing incoming signals; or switching from digitally processing incoming signals.

In some aspects, modifying the forwarding behavior comprises at least one of: switching from forwarding RS to generating and transmitting RS; or switching from generating and transmitting RS to forwarding RS.

In some aspects, modifying the forwarding behavior comprises at least one of: switching from receiving and processing a received signal to forwarding the received signal; or switching from forwarding the received signal to processing the received signal.

In some aspects, the method 1300 further includes receiving a configuration from the network entity. In some cases, the operations of this step refer to, or may be performed by, circuitry for receiving and/or code for receiving as described with reference to FIG. 15.

In some aspects, the method 1300 further includes detecting the change based on the configuration. In some cases, the operations of this step refer to, or may be performed by, circuitry for detecting and/or code for detecting as described with reference to FIG. 15.

In some aspects, the method 1300 further includes activating the modification of the forwarding behavior in response to receiving the configuration. In some cases, the operations of this step refer to, or may be performed by, circuitry for activating and/or code for activating as described with reference to FIG. 15.

In some aspects, the method 1300 further includes modifying the forwarding behavior further based on the configuration. In some cases, the operations of this step refer to, or may be performed by, circuitry for modifying and/or code for modifying as described with reference to FIG. 15.

In some aspects, the method 1300 further includes receiving a forwarding configuration that comprises a mapping between modifications to the forwarding behavior and sets of channel conditions, wherein the modification of the forwarding behavior is in accordance with the mapping. In some cases, the operations of this step refer to, or may be performed by, circuitry for receiving and/or code for receiving as described with reference to FIG. 15.

In some aspects, the method 1300 further includes detecting the change based on at least one of the sets of channel conditions. In some cases, the operations of this step refer to, or may be performed by, circuitry for detecting and/or code for detecting as described with reference to FIG. 15.

In some aspects, modifying the forwarding behavior comprises: notifying the network entity of the change; receiving a forwarding configuration from the network entity based on the change; and modifying the forwarding behavior in accordance with the received forwarding configuration.

In some aspects, the method 1300 further includes notifying the network entity of the modification of the forwarding behavior. In some cases, the operations of this step refer to, or may be performed by, circuitry for notifying and/or code for notifying as described with reference to FIG. 15.

In some aspects, forwarding the one or more communications in accordance with the modified forwarding behavior includes receiving the one or more communications in accordance with the modified forwarding behavior and then transmitting reproductions of the one or more communications in accordance with the modified forwarding behavior.

In one aspect, method 1300, or any aspect related to it, may be performed by an apparatus, such as communications device 1500 of FIG. 15, which includes various components operable, configured, or adapted to perform the method 1300. Communications device 1500 is described below in further detail.

Note that FIG. 13 is just one example of a method, and other methods including fewer, additional, or alternative steps are possible consistent with this disclosure.

### Example Operations by a Network Entity

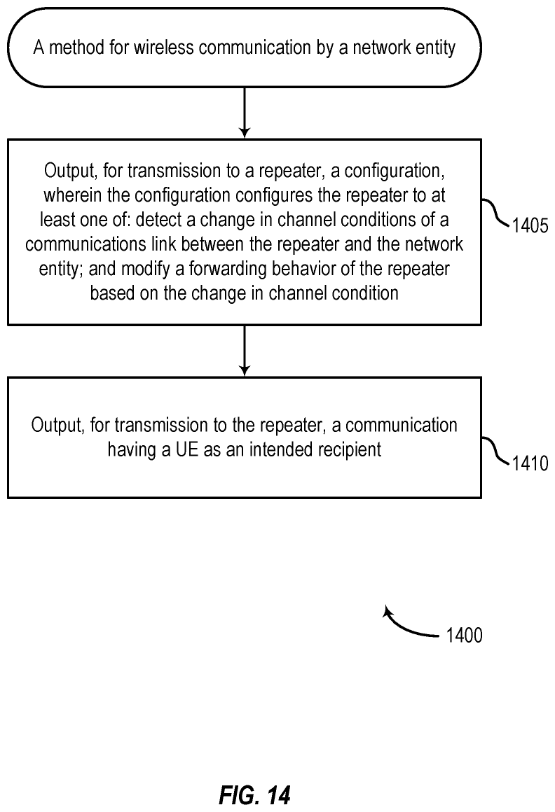

FIG. 14 shows an example of a method 1400 of wireless communication by a network entity, such as a BS 102 of FIGS. 1 and 3, or a disaggregated base station as discussed with respect to FIG. 2.

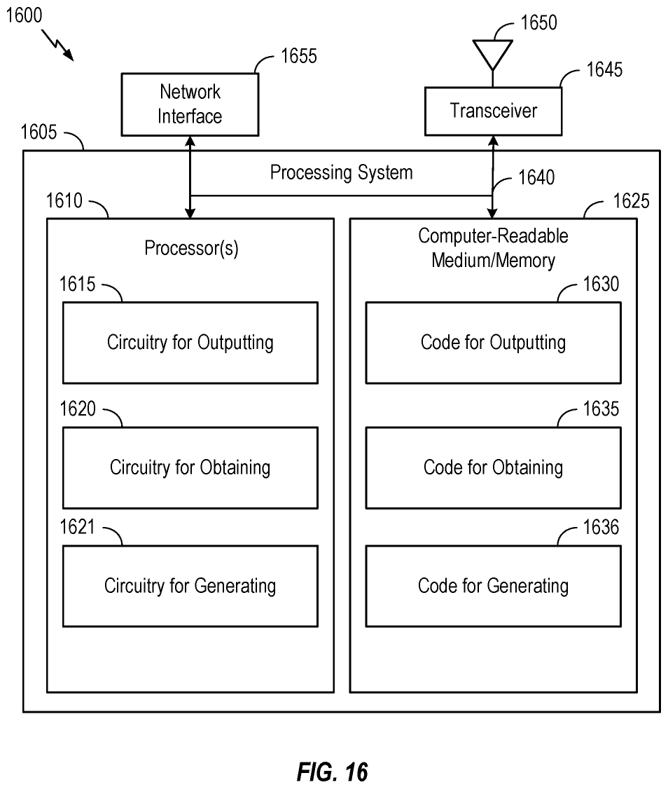

Method 1400 begins at step 1405 with outputting, for transmission to a repeater, a configuration, wherein the configuration configures the repeater to at least one of: detect a change in channel condition of a communications link between the repeater and the network entity; and modify a forwarding behavior of the repeater based on the change in channel condition. In some cases, the operations of this step refer to, or may be performed by, circuitry for outputting and/or code for outputting as described with reference to FIG. 16.

Method 1400 then proceeds to step 1410 with outputting, for transmission to the repeater, a communication having a UE as an intended recipient. In some cases, the operations of this step refer to, or may be performed by, circuitry for outputting and/or code for outputting as described with reference to FIG. 16.

In some aspects, the configuration further configures the repeater to at least one of: detect the change based on the configuration; activate the modification of the forwarding behavior in response to obtaining the configuration; or modify the forwarding behavior further based on the configuration.

In some aspects, the configuration comprises a mapping between modifications to the forwarding behavior of the repeater and sets of channel conditions.

In some aspects, the method 1400 further includes obtaining, from the repeater, a notification of the change; and generating the configuration based on the change.

In some aspects, the method 1400 further includes obtaining, from the repeater, an indication of a modification of the forwarding behavior. In some cases, the operations of this step refer to, or may be performed by, circuitry for obtaining and/or code for obtaining as described with reference to FIG. 16.

In one aspect, method 1400, or any aspect related to it, may be performed by an apparatus, such as communications device 1600 of FIG. 16, which includes various components operable, configured, or adapted to perform the method 1400. Communications device 1600 is described below in further detail.

Note that FIG. 14 is just one example of a method, and other methods including fewer, additional, or alternative steps are possible consistent with this disclosure.

### Example Communications Devices

FIG. 15 depicts aspects of an example communications device 1500. In some aspects, communications device 1500 is a user equipment, such as UE 104 described above with respect to FIGS. 1 and 3.

The communications device 1500 includes a processing system 1505 coupled to the transceiver 1585 (e.g., a transmitter and/or a receiver). The transceiver 1585 is configured to transmit and receive signals for the communications device 1500 via the antenna 1590, such as the various signals as described herein. The processing system 1505 may be configured to perform processing functions for the communications device 1500, including processing signals received and/or to be transmitted by the communications device 1500.

The processing system 1505 includes one or more processors 1510. In various aspects, the one or more processors 1510 may be representative of one or more of receive processor 358, transmit processor 364, TX MIMO processor 366, and/or controller/processor 380, as described with respect to FIG. 3. The one or more processors 1510 are coupled to a computer-readable medium/memory 1545 via a bus 1580. In certain aspects, the computer-readable medium/memory 1545 is configured to store instructions (e.g., computer-executable code) that when executed by the one or more processors 1510, cause the one or more processors 1510 to perform the method 1300 described with respect to FIG. 13, or any aspect related to it. Note that reference to a processor performing a function of communications device 1500 may include one or more processors 1510 performing that function of communications device 1500.

In the depicted example, computer-readable medium/memory 1545 stores code (e.g., executable instructions), such as code for modifying 1550, code for forwarding 1555, code for detecting 1560, code for receiving 1565, code for activating 1570, code for notifying 1571, code for ceasing 1572, code for switching 1573, code for adjusting 1574, code for generating 1575, code for processing 1576, code for obtaining 1577, and code for outputting 1578. Processing of the code for modifying 1550, code for forwarding 1555, code for detecting 1560, code for receiving 1565, code for activating 1570, code for notifying 1571, code for ceasing 1572, code for switching 1573, code for adjusting 1574, code for generating 1575, code for processing 1576, code for obtaining 1577, and code for outputting 1578 may cause the communications device 1500 to perform the method 1300 described with respect to FIG. 13, or any aspect related to it.

The one or more processors 1510 include circuitry configured to implement (e.g., execute) the code stored in the computer-readable medium/memory 1545, including circuitry such as circuitry for modifying 1515, circuitry for forwarding 1520, circuitry for detecting 1525, circuitry for receiving 1530, circuitry for activating 1535, circuitry for notifying 1536, circuitry for ceasing 1537, circuitry for switching 1538, circuitry for adjusting 1538, circuitry for generating 1540, circuitry for processing 1541, circuitry for obtaining 1542, and circuitry for outputting 1543. Processing with circuitry for modifying 1515, circuitry for forwarding 1520, circuitry for detecting 1525, circuitry for receiving 1530, circuitry for activating 1535, circuitry for notifying 1536, circuitry for ceasing 1537, circuitry for switching 1538, circuitry for adjusting 1538, circuitry for generating 1540, circuitry for processing 1541, circuitry for obtaining 1542, and circuitry for outputting 1543 may cause the communications device 1500 to perform the method 1300 described with respect to FIG. 13, or any aspect related to it.

Various components of the communications device 1500 may provide means for performing the method 1300 described with respect to FIG. 13, or any aspect related to it. For example, means for transmitting, sending, forwarding, notifying, or outputting (or means for outputting for transmission) may include transceivers 354 and/or antenna(s) 352 of the UE 104 illustrated in FIG. 3 and/or the transceiver 1585 and the antenna 1590 of the communications device 1500 in FIG. 15. Means for receiving, detecting, or obtaining may include transceivers 354 and/or antenna(s) 352 of the UE 104 illustrated in FIG. 3 and/or the transceiver 1585 and the antenna 1590 of the communications device 1500 in FIG. 15. Means for modifying, detecting, activating, deactivating, ceasing, switching, adjusting, notifying, generating, or processing may include one or more of the controller/processor 380, transmit processor 364, or the receive processor 358 illustrated in FIG. 3 and/or the processor(s) 1510 and computer-readable medium 1545 of the communications device 1500 in FIG. 15.

In some cases, rather than actually transmitting, for example, signals and/or data, a device may have an interface to output signals and/or data for transmission (a means for outputting). For example, a processor may output signals and/or data, via a bus interface, to a radio frequency (RF) front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 3. Notably, FIG. 15 is an example, and many other examples and configurations of communication device 1500 are possible.

FIG. 16 depicts aspects of an example communications device 1600. In some aspects, communications device 1600 is a network entity, such as BS 102 of FIGS. 1 and 3, or a disaggregated base station as discussed with respect to FIG. 2.

The communications device 1600 includes a processing system 1605 coupled to the transceiver 1645 (e.g., a transmitter and/or a receiver) and/or a network interface 1655. The transceiver 1645 is configured to transmit and receive signals for the communications device 1600 via the antenna 1650, such as the various signals as described herein. The network interface 1655 is configured to obtain and send signals for the communications device 1600 via communication link(s), such as a backhaul link, midhaul link, and/or fronthaul link as described herein, such as with respect to FIG. 2. The processing system 1605 may be configured to perform processing functions for the communications device 1600, including processing signals received and/or to be transmitted by the communications device 1600.

The processing system 1605 includes one or more processors 1610. In various aspects, one or more processors 1610 may be representative of one or more of receive processor 338, transmit processor 320, TX MIMO processor 330, and/or controller/processor 340, as described with respect to FIG. 3. The one or more processors 1610 are coupled to a computer-readable medium/memory 1625 via a bus 1640. In certain aspects, the computer-readable medium/memory 1625 is configured to store instructions (e.g., computer-executable code) that when executed by the one or more processors 1610, cause the one or more processors 1610 to perform the method 1400 described with respect to FIG. 14, or any aspect related to it. Note that reference to a processor of communications device 1600 performing a function may include one or more processors 1610 of communications device 1600 performing that function.

In the depicted example, the computer-readable medium/memory 1625 stores code (e.g., executable instructions), such as code for outputting 1630, code for obtaining 1635, and code for generating 1636. Processing of the code for outputting 1630, code for obtaining 1635, and code for generating 1636 may cause the communications device 1600 to perform the method 1400 described with respect to FIG. 14, or any aspect related to it.

The one or more processors 1610 include circuitry configured to implement (e.g., execute) the code stored in the computer-readable medium/memory 1625, including circuitry such as circuitry for outputting 1615 and circuitry for obtaining 1620. Processing with circuitry for outputting 1615 and circuitry for obtaining 1620 may cause the communications device 1600 to perform the method 1400 described with respect to FIG. 14, or any aspect related to it.

Various components of the communications device 1600 may provide means for performing the method 1400 described with respect to FIG. 14, or any aspect related to it. Means for transmitting, sending, or outputting (or means for outputting for transmission) may include transceivers 332 and/or antenna(s) 334 of the BS 102 illustrated in FIG. 3 and/or the transceiver 1645 and the antenna 1650 of the communications device 1600 in FIG. 16. Means for receiving or obtaining may include transceivers 332 and/or antenna(s) 334 of the BS 102 illustrated in FIG. 3 and/or the transceiver 1645 and the antenna 1650 of the communications device 1600 in FIG. 16. Means for generating may include one or more of the controller/processor 340, transmit processor 320, or the receive processor 338 illustrated in FIG. 3 and/or the processor(s) 1610 and computer-readable medium 1625 of the communications device 1600 in FIG. 16.

In some cases, rather than actually transmitting, for example, signals and/or data, a device may have an interface to output signals and/or data for transmission (a means for outputting). For example, a processor may output signals and/or data, via a bus interface, to a radio frequency (RF) front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 3. Notably, FIG. 16 is an example, and many other examples and configurations of communication device 1600 are possible.

### EXAMPLE CLAUSES

Implementation examples are described in the following numbered clauses:

Clause 1: A method for wireless communications at a repeater, comprising: modifying a forwarding behavior based on a change in channel condition of a communications link between the repeater and a network entity; and forwarding one or more communications between the network entity and a UE in accordance with the modified forwarding behavior.

Clause 2: The method of Clause 1, further comprising: detecting the change based on a condition involving at least one of: a reference signal measurement; or a power measurement within a bandwidth.

Clause 3: The method of any one of Clauses 1 and 2, further comprising: detecting the change based on at least one of: activation of a TCI state for a MT of the repeater; or a change of a beam of a backhaul link for the repeater.

Clause 4: The method of any one of Clauses 1-3, wherein modifying the forwarding behavior comprises at least one of: activating forwarding by the repeater; deactivating forwarding by the repeater; modifying a beam-specific amplification gain of the repeater; modifying an access beam configuration of the repeater; modifying an access beam sweep pattern of the repeater; or ceasing transmitting a beam.

Clause 5: The method of any one of Clauses 1-4, wherein modifying the forwarding behavior comprises modifying the forwarding behavior for downlink communications from the network entity independent of the forwarding behavior for uplink communications to the network entity.

Clause 6: The method of any one of Clauses 1-5, wherein modifying the forwarding behavior comprises at least one of: switching to an autonomous mode of operation; switching from the autonomous mode of operation; adjusting a receive timing reference; adjusting a forwarding timing reference; switching to digitally processing incoming signals; or switching from digitally processing incoming signals.

Clause 7: The method of any one of Clauses 1-6, wherein modifying the forwarding behavior comprises at least one of: switching from forwarding RS to generating and transmitting RS; or switching from generating and transmitting RS to forwarding RS.

Clause 8: The method of any one of Clauses 1-7, wherein modifying the forwarding behavior comprises at least one of: switching from receiving and processing a received signal to forwarding the received signal; or switching from forwarding the received signal to processing the received signal.

Clause 9: The method of any one of Clauses 1-8, further comprising: receiving a configuration from the network entity; and at least one of: detecting the change based on the configuration; activating the modification of the forwarding behavior in response to receiving the configuration; or modifying the forwarding behavior further based on the configuration.

Clause 10: The method of any one of Clauses 1-9, further comprising: receiving a forwarding configuration that comprises a mapping between modifications to the forwarding behavior and sets of channel conditions, wherein the modification of the forwarding behavior is in accordance with the mapping; and detecting the change based on at least one of the sets of channel conditions.

Clause 11: The method of any one of Clauses 1-10, wherein modifying the forwarding behavior comprises: notifying the network entity of the change; receiving a forwarding configuration from the network entity based on the change; and modifying the forwarding behavior in accordance with the received forwarding configuration.

Clause 12: The method of any one of Clauses 1-11, further comprising: notifying the network entity of the modification of the forwarding behavior.

Clause 13: The method of any one of Clauses 1-12, wherein forwarding the one or more communications comprises: obtaining the one or more communications in accordance with the modified forwarding behavior; and outputting, for transmission, reproductions of the one or more communications in accordance with the modified forwarding behavior.

Clause 14: A method for wireless communication by a network entity, comprising: outputting, for transmission to a repeater, a configuration, wherein the configuration configures the repeater to at least one of: detect a change in channel condition of a communications link between the repeater and the network entity; and modify a forwarding behavior of the repeater based on the change in channel condition; and outputting, for transmission to the repeater, a communication having a UE as an intended recipient.

Clause 15: The method of Clause 14, wherein the configuration further configures the repeater to at least one of: detect the change based on the configuration; activate the modification of the forwarding behavior in response to obtaining the configuration; or modify the forwarding behavior further based on the configuration.

Clause 16: The method of any one of Clauses 14-15, wherein the configuration comprises a mapping between modifications to the forwarding behavior of the repeater and sets of channel conditions.

Clause 17: The method of any one of Clauses 14-16, further comprising: obtaining, from the repeater, a notification of the change; and generating the configuration based on the change.

Clause 18: The method of any one of Clauses 14-17, further comprising: obtaining, from the repeater, an indication of a modification of the forwarding behavior.

Clause 19: An apparatus, comprising: a memory comprising executable instructions; and a processor configured to execute the executable instructions and cause the apparatus to perform a method in accordance with any one of Clauses 1-18.

Clause 20: An apparatus, comprising means for performing a method in accordance with any one of Clauses 1-18.

Clause 21: A non-transitory computer-readable medium comprising executable instructions that, when executed by a processor of an apparatus, cause the apparatus to perform a method in accordance with any one of Clauses 1-18.

Clause 22: A computer program product embodied on a computer-readable storage medium comprising code for performing a method in accordance with any one of Clauses 1-18.

Clause 23: A repeater, comprising: at least one transceiver; a memory comprising processor-executable instructions; and one or more processors configured to execute the processor-executable instructions and cause the repeater to perform a method in accordance with any one of Clauses 1-13, wherein the at least one transceiver is configured to forward the one or more communications between the network entity and the UE.

Clause 24: A network entity, comprising: at least one transceiver; a memory comprising processor-executable instructions; and one or more processors configured to execute the processor-executable instructions and cause the network entity to perform a method in accordance with any one of Clauses 14-18, wherein the at least one transceiver is configured to transmit the configuration and the communication having the UE as the intended recipient.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communications, comprising:
a memory comprising processor-executable instructions; and
one or more processors configured to execute the processor-executable instructions and cause the apparatus to:
modify a forwarding behavior based on a change in channel condition of a communications link between the apparatus and a network entity; and
forward one or more communications between the network entity and a user equipment (UE) in accordance with the modified forwarding behavior.

2. The apparatus of claim 1, wherein the one or more processors are further configured to cause the apparatus to detect the change based on a condition involving at least one of:
a reference signal measurement; or
a power measurement within a bandwidth.

3. The apparatus of claim 1, wherein the one or more processors are further configured to apparatus to detect the change based on at least one of:
activation of a transmission configuration indicator (TCI) state for a mobile termination (MT) of the apparatus; or
a change of a beam of a backhaul link for the apparatus.

4. The apparatus of claim 1, wherein the one or more processors being configured to modify the forwarding behavior comprises the one or more processors being configured to cause the apparatus to at least one of:
activate forwarding;
deactivate forwarding;
modify a beam-specific amplification gain;
modify an access beam configuration;
modify an access beam sweep pattern; or
cease transmitting a beam.

5. The apparatus of claim 1, wherein the one or more processors being configured to modify the forwarding behavior comprises the one or more processors being configured to modify the forwarding behavior for downlink communications from the network entity independent of the forwarding behavior for uplink communications to the network entity.

6. The apparatus of claim 1, wherein the one or more processors being configured to modify the forwarding behavior comprises the one or more processors being configured to cause the apparatus to at least one of:
switch to an autonomous mode of operation;
switch from the autonomous mode of operation;
adjust a receive timing reference;
adjust a forwarding timing reference;
switch to digitally processing incoming signals; or
switch from digitally processing incoming signals.

7. The apparatus of claim 1, wherein the one or more communications comprise reference signals (RS) and wherein the one or more processors being configured to modify the forwarding behavior comprises the one or more processors being configured to at least one of:
switch from outputting, for transmission, reproductions of obtained RS to generating RS and outputting, for transmission, the generated RS; or
switch from generating a RS and outputting for transmission the generated RS to obtaining RS and outputting, for transmission, reproductions of the obtained RS.

8. The apparatus of claim 1, wherein the one or more processors being configured to modify the forwarding behavior comprises the one or more processors being configured to at least one of:
switch from obtaining a signal and processing the obtained signal to outputting, for transmission, a reproduction of the obtained signal; or
switch from obtaining a signal and outputting, for transmission, a reproduction of the obtained signal to obtaining a signal and processing the obtained signal.

9. The apparatus of claim 1, wherein the one or more processors are further configured to:
obtain a configuration from the network entity; and at least one of:
detect the change based on the configuration;
activate the modification of the forwarding behavior in response to obtaining the configuration; or
modify the forwarding behavior further based on the configuration.

10. The apparatus of claim 1, wherein the one or more processors are further configured to:
obtain a forwarding configuration that comprises a mapping between modifications to the forwarding behavior and sets of channel conditions, wherein the modification of the forwarding behavior is in accordance with the mapping; and
detect the change based on at least one of the sets of channel conditions.

11. The apparatus of claim 1, wherein the one or more processors being configured to modify the forwarding behavior comprises the one or more processors being configured to:
notify the network entity of the change;
obtain a forwarding configuration from the network entity based on the change; and
modify the forwarding behavior in accordance with the obtained forwarding configuration.

12. The apparatus of claim 1, wherein the one or more processors are further configured to:
notify the network entity of the modification of the forwarding behavior.

13. The apparatus of claim 1, wherein the one more processors being configured to cause the apparatus to forward the one or more communications comprises the one or more processors being configured to:
obtain the one or more communications in accordance with the modified forwarding behavior; and
output, for transmission, reproductions of the one or more communications in accordance with the modified forwarding behavior.

14. An apparatus for wireless communications, comprising:
a memory comprising processor-executable instructions; and
one or more processors configured to execute the processor-executable instructions and cause the apparatus to:
output, for transmission to a repeater, a configuration, wherein the configuration configures the repeater to at least one of:
detect a change in channel condition of a communications link between the repeater and the network entity; and
modify a forwarding behavior of the repeater based on the change in channel condition; and
output, for transmission to the repeater, a communication having a user equipment (UE) as an intended recipient.

15. The apparatus of claim 14, wherein the configuration further configures the repeater to at least one of:
detect the change based on the configuration;
activate the modification of the forwarding behavior in response to obtaining the configuration; or
modify the forwarding behavior further based on the configuration.

16. The apparatus of claim 14, wherein the configuration comprises a mapping between modifications to the forwarding behavior of the repeater and sets of channel conditions.

17. The apparatus of claim 14, wherein the one or more processors are further configured to:
obtain, from the repeater, a notification of the change; and
generate the configuration based on the change.

18. The apparatus of claim 14, wherein the one or more processors are further configured to:
obtain, from the repeater, an indication of a modification of the forwarding behavior.

19. The apparatus of claim 14, further comprising at least one transceiver configured to transmit the configuration and the communication, wherein the apparatus is configured as a network entity.

20. A repeater, comprising:
at least one transceiver;
a memory comprising processor-executable instructions; and
one or more processors configured to execute the processor-executable instructions and cause the repeater to:
modify a forwarding behavior based on a change in channel condition of a communications link between the repeater and a network entity; and
forward, via the at least one transceiver, one or more communications between the network entity and a user equipment (UE) in accordance with the modified forwarding behavior.
